(19) United States
(12) Patent Application Publication
(10) Pub. No.: US 2008/0032262 A1
(43) Pub. Date: Feb. 7, 2008

(54) DENTAL IMPLANT SYSTEM AND METHOD THEREOF

(76) Inventor: Vitali Bondar, Portsmouth, NH (US)

Correspondence Address: NOTARO AND MICHALOS, 100 DUTCH HILL ROAD, SUITE 110, ORANGEBURG, NY, 10962-2100, US

(21) Appl. No.: 11/615,131

(22) Filed: Dec. 22, 2006

Related U.S. Application Data
(60) Provisional application No. 60/834,891, filed on Aug. 1, 2006.

(51) Int. Cl. A61C 8/00

(52) U.S. Cl. 433/173

(57) ABSTRACT

A dental implant system comprising an implant member, an abutment member and a transfer key with cooperatively engaging structures for ensuring proper alignment and orientation of an abutment assembled on the implant member and for preparing an accurate dental impression and mold which represents the implantation site and its relationship to adjacent teeth structures. A dental reconstruction method utilizing the dental implant system of the present invention is also disclosed.

This application claims benefit of U.S. Ser. No. 60/834,891, filed Aug. 1, 2006, the disclosures of which are incorporated herein by reference in their entirety.

### FIELD AND BACKGROUND OF THE INVENTION

The present invention relates in general to a dental implant system and method, comprising components with improved surface and structural features for ensuring proper alignment and orientation of an abutment assembled on a dental implant and for preparing accurate dental impression and mold representing the implantation site and its relationship to adjacent teeth structures.

Internal Morse taper connection, also referred to as the locking taper, is known in implant dentistry and are commonly used for securing an abutment to a dental implant. A widely used example is the implant described in U.S. Pat. No. 4,738,623 to Driskell. See also U.S. Pat. No. 5,888,066 to Morgan and U.S. Pat. No. 6,290,500 to Morgan, et al. for examples of other Morse taper abutment-to-implant connections.

Implant systems utilizing screw-less internal Morse taper connection have inherent disadvantages when compared to more widely used screwed retained, internal or external hex dental implants. These disadvantages include: (1) the round shape of the female and male components makes it difficult to register the position of the prepared implant abutment; (2) the implant abutment may not travel in a straight line when tapped into the implant; (3) the round shape of the female and male components make it difficult to prevent rotation of the implant abutment once the final restoration is under stress; (4) the implant abutment may be over inserted into the implant as compared to the implant analog; and (5) the implant abutment may not be inserted into the implant as far as it was inserted into the implant analog.

Numerous other designs have been proposed, but none has satisfactorily solve the above described problems.

U.S. Pat. No. 6,857,874 to Kim discloses an abutment supported axially through its circular bore hole by a screw. The side surface of the screw have grooves for receiving locking sleeves which cooperate with slits on the abutment to prevent the screw installed in the dental fixture from loosening.

U.S. Pat. No. 6,159,010 to Rogers, et al. discloses a dental coping mounted on an abutment post. The dental coping includes apertures for providing access to the longitudinal grooves of the abutment post. This allows the artificial tooth to be integrally formed on the dental coping with non-rotational features for engaging the grooves on the abutment post.

U.S. Pat. No. 6,488,502 to Weber discloses a transfer element for transferring the position of an implanted dental implant to a master model, comprising a sleeve for transferring the anti-rotational feature and the axial position of the implant to the impression material, and a core which is inserted through the sleeve and into the implant.

U.S. Pat. No. 6,6068,478 to Grande, et al. discloses a dental impression system which comprises an impression cap for transferring an end of an implant to a master cast.

All of the above references are incorporated herein by reference.

### SUMMARY OF THE INVENTION

Therefore, the aim of the present invention is to provide dental implant system and method which is capable of eliminating the disadvantages of the prior art and in particular a dental implant system which has surface and structural features which provide accurate placement of the abutment and replication of the implantation site.

It is an object of the present invention to provide a dental implant system comprising an implant member or body, an abutment member (e.g., transfer coping/abutment or implant abutment), and a transfer key.

The implant member generally has an anchoring portion on one end for anchoring the implant member in the patient's jaw bone, and an abutment receiving portion or post on the other end. At least a part or a cross-section of the abutment receiving portion is tapered to a smaller diameter toward the free end of the abutment receiving portion. The abutment receiving portion has a plurality of spaced apart longitudinal grooves, which extend downward from the free end.

The transfer key generally comprises a number of projecting members or projections, which extend axially outward from one end of the transfer key. The projections are arranged and configured so as to allow mating engagement with the corresponding grooves of the abutment receiving portion. The transfer key also includes an elongated rail formed on the circumferential or peripheral surface of the transfer key and extending substantially its entire length.

The abutment member generally includes an axial bore which passes through its center. The axial bore has a lower tapered cross-section, configured to receive and mate with the tapered part of the abutment receiving portion, and an upper cross-section corresponding to the outer cross-section of the transfer key.

Another object of the present invention is to provide an improved method of impression making and dental reconstruction utilizing the components of the dental implant system of the present invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a perspective view of a dental implant system or assembly of the present invention;

FIG. 2 is a side cut-away view of a dental implant system or assembly of the present invention;

FIG. 3 is a (a) top and (b) side view of a dental implant of the present invention;

FIG. 4 is a (a) side and (b) bottom view of a transfer key of the present invention;

FIG. 5 is a (a) top and (b) side cut-away view of a transfer abutment of the present invention; and

FIG. 6 is a (a) top and (b) side cut-away view of an implant abutment of the present invention.

### DESCRIPTION OF THE PREFERRED EMBODIMENTS

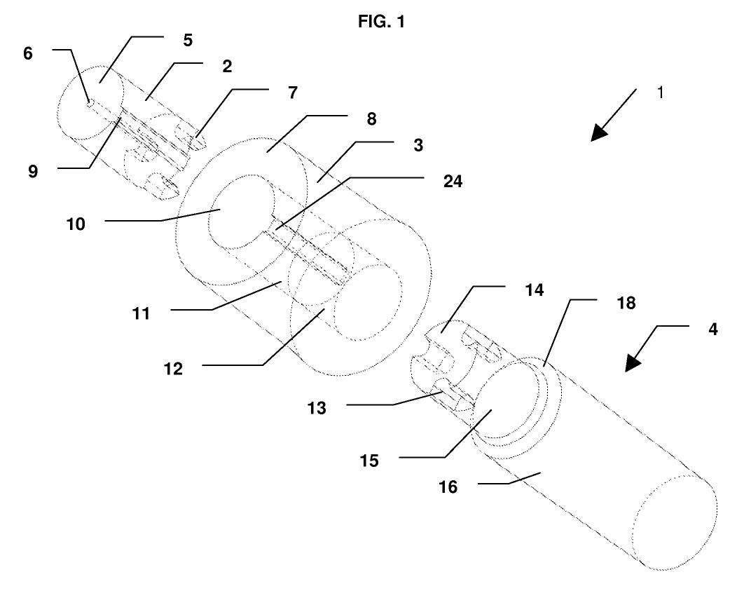

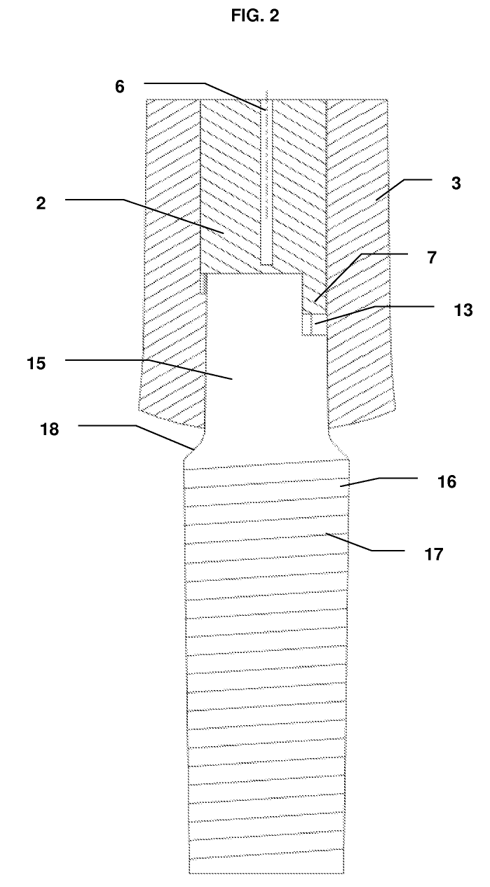

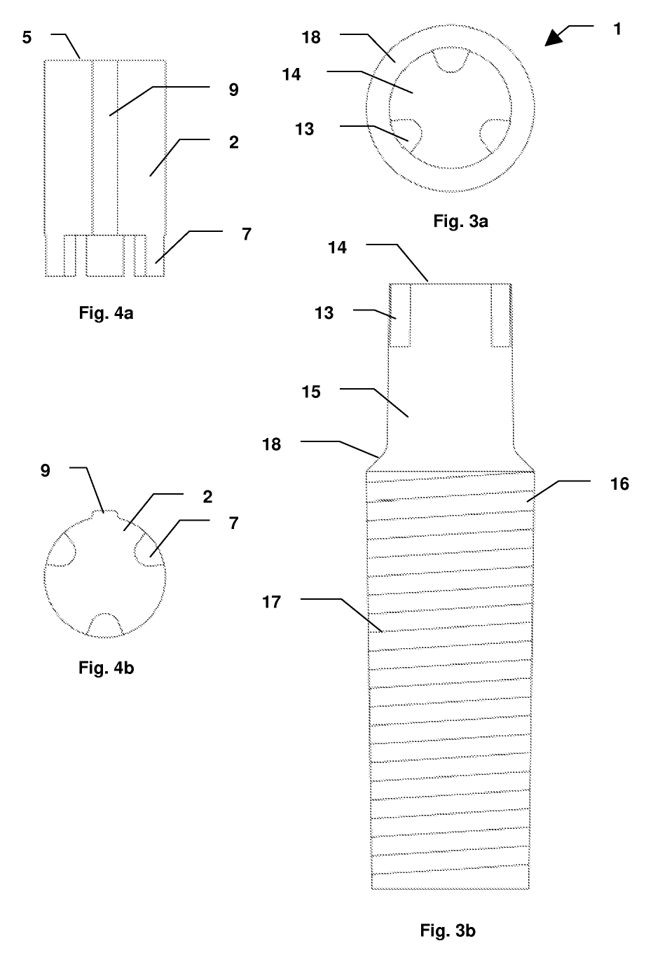

Referring now to the drawings, in which like reference numerals are used to refer to the same or similar elements, FIG. 1 shows a dental implant system 1 comprising a implant member 4 or body/fixture, an abutment member 3, 21, and a transfer key 5. The implant member 4 includes an anchoring portion 16 on one end for anchoring the implant member 4 in the patient's jaw bone, and an abutment receiving portion 15 or post on the other end. The end of the anchoring portion 16 adjoining the abutment receiving portion 15 may be provided with a shoulder 18, such as a downwardly and outwardly sloping shoulder. Preferably, the anchoring portion 16 is provided with external threads 17 (FIG. 2). The anchoring portion 16 may be formed integrally with the abutment receiving portion 15, or connected to each other to form the implant member 4. The abutment member 3, 21 may be straight or angled. FIGS. 3a and 3b respectively show a top and side view of an implant member 4 of the present invention.

At least a part or a cross-section of the abutment receiving portion 15 is tapered to a smaller diameter toward distal end 14. The abutment receiving portion 15 is provided with a plurality of spaced apart longitudinal grooves 13 that extend a predetermined distance in a lengthwise direction away from distal end 14. Preferably, the grooves 13 are equally spaced and/or parallel to each other. In one embodiment, the abutment receiving portion 15 has three equally spaced and parallel grooves 13, which extend some length of the abutment receiving portion 15.

The above mentioned transfer key 2 comprises a number of projecting members or projections 7, which extend axially outward from one end of the transfer key 2. The projections 7 are arranged and configured so as to allow mating engagement with the corresponding grooves 13 of the abutment receiving portion 15. It is apparent to those skilled in the art that variations in the number, shape and size of the grooves and projections are possible, and that such changes, variations, modifications, and other uses and applications which do not depart from the spirit and scope of the invention are deemed to be covered by the invention, and are limited only by the claims which follow.

The transfer key 2 also includes an elongated rail member 9 extending lengthwise along its circumferential or peripheral surface. The transfer key 2 is fabricated from a suitable polymer, plastic or metallic material. FIGS. 4a and 4b respectively show a side and bottom view of a transfer key 2 of the present invention.

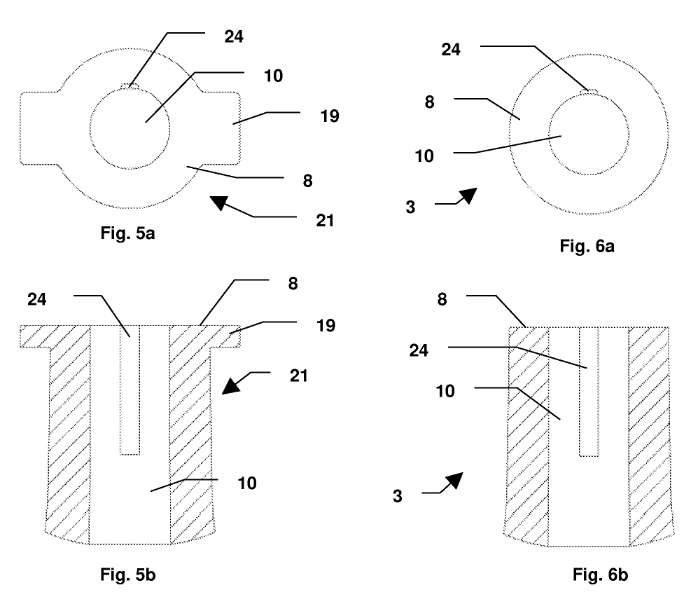

The above mentioned abutment member 3, 21 has an axial bore 10, preferably, running through its center. The axial bore 10 includes a lower tapered cross-section 12, which is configured to receive and mate with the tapered part of the abutment receiving portion 15, and an upper cross-section 11 corresponding to the outer cross-section of the transfer key 2. Preferably, the tapered cross-section 12 and the tapered part of the abutment receiving portion 15 form a Morse taper connection. A lengthwise extending channel 24, which corresponds to the rail member 9, is formed on the inner circumferential surface of the abutment member 3, 21, in the upper cross-section 11 of the axial bore 10. FIGS. 5a and 5b respectively show a top and side cut-away view of abutment member 21 with retention members 19 or elements. FIGS. 6a and 6b respectively show a top and side cut-away view of abutment member 3.

In one embodiment, abutment member 21 (also referred to as a transfer coping or transfer abutment) is up to 0.25 mm longer than abutment member 3 (also referred to as an implant abutment). Abutment member 21 is adapted to cover up to 0.25 mm more of the length of the abutment receiving portion 15 or post than abutment member 3 when an impression of the abutment member 21 and the surrounding dentition is obtained. This is to ensure full insertion of abutment member 3 on the implant analog; otherwise, the master cast or mold will interfere with abutment seating.

The transfer key 2 may also include a central bore 6 for engaging a suitable actuating or extraction tool therethrough, such as an endodontic file or a root canal reamer, to extract the transfer key 2 when mounted on the abutment receiving portion 15 and within the axial bore 10 of the abutment member 3, 21.

In one embodiment, the outer surface of abutment member 3 is provided with at least one anti-rotational element or feature, such as a groove, recess or projection, to provide secure attachment of the implant prosthesis to abutment member 3. Abutment member 21 may have disposed on its outer surface at least one retention member 19 or element to provide secure attachment of abutment member 21 to the dental impression material used, for example, in the “pick-up” modelling of the patient's mouth. This type of modelling technique is described in the background section of U.S. Pat. Nos. 6,824,386 and 6,951,460 to Halldin, et al., the disclosures of which are incorporated herein by reference.

When assembled, the components of the dental implant system, such as the grooves 13, projections 7, rail member 9 and channel 24, operate cooperatively with each other to prevent unwanted movement or rotation of the abutment member 3,21 relative to the implant member 4 or the implant analog. The arrangement of the various components of the dental implant system of the present invention also, in addition to the above mentioned advantages, provides accurate three-dimensional abutment registration and modelling of the implant site, ensures abutment member 3, 21 travels in a straight line, e.g., when tapped into place, during abutment seating, and/or prevents over insertion of the abutment member 3, 21.

The exemplary embodiment for performing dental reconstruction using the dental implant system of the present invention will be described below in detail. However, it will be apparent to one of ordinary skill in the art that other embodiments are also possible in which various steps are added, combined, modified, substituted, automated or omitted.

The anchoring portion 16 of the implant member 4 is implanted in the patient's jaw bone. Preferably, the anchoring portion has threads 17 for securing the implant member 4 to the bone.

The transfer abutment 21 is then placed over the abutment receiving portion 15. Preferably, the transfer abutment 21 covers slightly more of the abutment receiving portion 15. This is to prevent the master cast from interfering with the seating of the implant abutment 3 on the implant analog. The transfer abutment 21 may include retention element(s) 19 for retention of the transfer abutment 21 in the impression material.

The transfer coping key is inserted into the axial bore 10 of the transfer abutment 21 with the rail member sliding within channel 24 of the transfer abutment 21.

The transfer abutment 21 is rotated to align the axially extending projections on the transfer coping key with the corresponding grooves 13 of the abutment receiving portion 15 and to engage the projections with the grooves. In this way, an accurate three-dimensional implant position registration is obtained.

Slight pressure is applied to the transfer abutment 21 to engage the Morse taper abutment-to-implant connection formed by the respective male and female mating surfaces on the abutment receiving portion 15 and the transfer abutment 21.

Impression material is applied to the patient's mouth to obtain a negative impression of the transfer abutment 21 and the surrounding dentition.

Impression material is removed from the patient's mouth with the transfer abutment 21 and transfer coping key embedded within.

The implant analog (post) is inserted into the transfer abutment 21. The distal end of the implant analog is provided with grooves which correspond to and engage with the projections of the transfer coping key. Preferably, a Morse taper connection is formed by the respective male and female mating surfaces on the implant analog and the transfer abutment 21. The transfer coping key retained in the impression material also acts as stop to prevent over insertion of the implant analog.

Molding material is poured into the negative impression of the surrounding dentition and around the transfer abutment 21.

The impression material is removed from the hardened molding material. The transfer abutment 21 remains embedded in the impression material.

The implant abutment 3 is placed over the distal end of the implant analog extending from the hardened molding material.

A transfer key is inserted into the axial bore 10 of the implant abutment 3, in particular the upper cross-section 11 of the axial bore 10, with the rail member 9 sliding within channel 24 of the implant abutment 3. The transfer coping key or a different key similar to the transfer coping key may be used as the transfer key. The transfer key has axially extending projections corresponding to the grooves 13 of the abutment receiving portion 15 of the implant member 4.

The implant abutment 3 is rotated to align the projections 7 on the transfer key with the corresponding grooves on the implant analog and to engage the projections with the grooves. The upper end 5 of the key is trimmed to a length, preferably 1-2 mm, above the occlusal surface 8 of the implant abutment 3.

Slight pressure is applied to the implant abutment 3 to engage the Morse taper connection formed by the respective male and female mating surfaces on the implant analog and the implant abutment 3. Preferably, seating of the implant abutment 3 is also performed with an hollow cylindrical tapping instrument so as not to interfere with the transfer key. The instrument may have a striking surface which corresponds to the occlusal surface 8 of the implant abutment 3. The transfer key registers the vertical position of the implant abutment 3, which ensures that the implant abutment 3 (and similarly in the case of transfer abutment 21) travels in a straight line when it is tapped into place. Optionally, with the transfer key remaining inside the implant abutment 3, the implant abutment 3 may be prepared to the desired shape.

An implant prosthesis or crown is made over the implant abutment 3.

Before or after the dental prosthesis or crown is made, an acrylic jig may be fabricated over the occlusal surface 8 of the implant abutment 3 with the transfer key remaining inside the implant abutment 3.

The transfer key is removed from the implant abutment 3. Preferably, an extraction tool adapted to engage the central bore 6 of the transfer key is used to extract the transfer key.

The implant abutment 3 is removed from the implant analog using rotational movement. The customized implant abutment 3, transfer key, acrylic jig and dental prosthesis fabricated in the manner described above is then sent or provided to the dental practitioner for installation into the dental implant or fixture implanted into the patient's jaw bone.

The implant abutment 3 is first placed on the abutment receiving portion 15 of the implant member 4 implanted in the patient's jaw bone. The transfer key is inserted into the implant abutment 3 with the rail member 9 sliding within channel 24 of the implant abutment 3.

The implant abutment 3 is then rotate to align the projections 7 on the transfer key with the grooves 13 of the abutment receiving portion 15 and to engage the projections 7 with the grooves 13.

Slight pressure may be applied to the implant abutment 3 to engage the Morse taper abutment-to-implant connection formed by the respective male and female mating surfaces provided on the abutment receiving portion 15 and the implant abutment 3. The transfer key registers the vertical position of the implant abutment 3, and ensures that the implant abutment 3 travels in a straight line during abutment seating.

In an embodiment, the acrylic jig is placed on the occlusal surface 8 of the implant abutment 3 with the transfer key inserted, and a tapping force is applied, for example, with the tapping instrument described above, to seat the implant abutment 3 via the acrylic jig. The acrylic jig acts as a stop against the transfer key preventing over insertion of the implant abutment 3 on the abutment receiving portion 15.

Abutment seating is performed until the occlusal surface 8 of the implant abutment 3 is at the same level as the upper end of the transfer key 5.

Finally, the dental prosthesis or crown is securely attached to the implant abutment 3.

While specific embodiments of the invention have been shown and described in detail to illustrate the application of the principles of the invention, it will be understood that the invention may be embodied otherwise without departing from such principles.

What is claimed is:

1. A dental implant system, comprising:
an implant member comprising an anchoring portion for anchoring the implant member in a patient's jaw bone and an abutment receiving portion adjoining and extending from one end of the anchoring portion, wherein at least a part of the abutment receiving portion is tapered to a smaller diameter toward a distal end thereof and comprises a plurality of spaced apart grooves extending a predetermined distance in a lengthwise direction away from the distal end of the abutment receiving portion;
a transfer key comprising a plurality of complementary projections extending axially outward from one end thereof for engaging the grooves on the abutment receiving portion and a rail member extending lengthwise along a peripheral surface of the transfer key; and
an abutment member having an axial bore, wherein the axial bore comprises a lower tapered cross-section dimensioned to mate with at least the tapered part of the abutment receiving portion, and an upper cross-section corresponding to the outer cross-section of the transfer key, and wherein the upper cross-section of the axial bore comprises a lengthwise extending channel formed on an inner surface thereof and corresponding to the rail member on the transfer key.

2. The dental implant system of claim 1, wherein the anchoring portion comprises external threads.

3. The dental implant system of claim 1, wherein the anchoring portion is formed integrally with the abutment receiving portion.

4. The dental implant system of claim 1, wherein the anchoring portion and the abutment receiving portion are connected to form the implant member.

5. The dental implant system of claim 1, wherein at least the tapered part of the abutment receiving portion and the tapered cross-section of the axial bore are correspondingly shaped and sized to form a morse taper connection.

6. The dental implant system of claim 1, wherein the grooves are equally spaced.

7. The dental implant system of claim 6, wherein the grooves are parallel to each other.

8. The dental implant system of claim 1, wherein a proximal end of the anchoring portion comprises a downwardly and outwardly sloping shoulder.

9. The dental implant system of claim 1, wherein the grooves, projections, rail member and channel are configured and arranged to cooperatively prevent the movement or rotation of the abutment member relative to the implant member.

10. The dental implant system of claim 1, wherein the outer surface of the abutment member comprises at least one anti-rotational element to provide secure attachment of a dental crown to the abutment member.

11. The dental implant system of claim 1, wherein the outer surface of the abutment member comprises at least one retention element to provide secure attachment of the abutment member within a dental impression material.

12. The dental implant system of claim 1, wherein the transfer key comprises a central bore for attaching a suitable extraction tool to extract the transfer key mounted on the abutment receiving portion and within the axial bore of the abutment member.

13. The dental implant system of claim 12, wherein the extraction tool is an endodontic file.

14. The dental implant system of claim 1, wherein the height of the transfer key is selected to prevent over insertion of the abutment member.

15. The dental implant system of claim 1, wherein the abutment receiving portion comprises three equally spaced parallel grooves and the transfer key comprises three corresponding projections.

16. The dental implant system of claim 1, wherein the transfer key is formed of a suitable polymer, plastic or metal.

17. The dental implant system of claim 1, wherein the abutment member is formed at a desired angle.

18. The dental implant system of claim 1, wherein the axial bore extends through the center of the abutment member.

19. A method of dental reconstruction, comprising the steps of:
(a) implanting an anchoring portion of an implant body in a patient's jaw bone, wherein the implant body comprises an abutment receiving portion adjoining and extending outwardly from the anchoring portion, and wherein at least a part of the abutment receiving portion is tapered to a smaller diameter toward a distal end thereof and comprises a plurality of first spaced apart grooves extending a predetermined distance in a lengthwise direction away from the distal end of the abutment receiving portion;
(b) placing a transfer abutment over the abutment receiving portion, wherein the transfer abutment comprises a first axial bore, and wherein the first axial bore comprises a first lower tapered cross-section dimensioned to mate with at least the tapered part of the abutment receiving portion, and a first upper cross-section having a first channel formed on a first inner surface thereof;
(c) inserting a first transfer key into the first axial bore, wherein the first transfer key comprises on one end thereof a plurality of first axially extending projections corresponding to and engaging the first grooves on the abutment receiving portion, and on a first peripheral surface thereof a first rail member corresponding to and engaging the first channel;
(d) releasably engaging the abutment receiving portion and the first tapered cross-section of the axial bore;
(e) forming a dental impression with impression material, wherein the transfer abutment and the first transfer key transfer with the impression material upon removal from the patient's mouth;
(f) inserting an implant analog member with second grooves corresponding to the first projections of the first transfer key and with a tapered portion corresponding to the first tapered cross-section of the first axial hole into respective mating engagement with each other;
(g) forming a model of the dental impression including the implant analog member, wherein the model replicates an area of the patient's mouth surrounding the transfer abutment member when seated over the abutment receiving portion of implant body implanted in the patient's jaw bone;
(h) creating a dental prosthesis assembly using the model; and
(i) installing the dental prosthesis assembly over abutment receiving portion of the implant body.

20. The method of claim 19, wherein the dental prosthesis assembly creation step further comprises:
(a) placing an implant abutment over the implant analog member, wherein the implant abutment comprises a second axial bore, and wherein the second axial bore comprises a second lower tapered cross-section dimensioned to mate with at least the tapered portion of the implant analog member, and a second upper cross-section having a second channel formed on a second inner surface thereof;
(b) inserting a second transfer key into the second axial bore, wherein the second transfer key comprises on one end thereof a plurality of second axially extending projections corresponding to and engaging the second grooves on the implant analog member, and on a second peripheral surface thereof a second rail member corresponding to and engaging the second channel;
(c) forming a dental crown over the implant abutment;
(d) removing the second key from the implant abutment and then removing the implant abutment from the implant analog member;
(e) placing the implant abutment over the abutment receiving portion of the implant body;
(f) inserting the second transfer key into implant abutment to register the second rail member with the corresponding second channel;
(g) rotating the implant abutment to engage the second projections of the second transfer key with the corresponding first grooves of the abutment receiving portion; and
(h) securely engaging the implant abutment and the abutment receiving portion.

21. The method of claim 20, wherein the first and second transfer keys are identical.

22. The method of claim 20, wherein the first transfer key is used instead of the second transfer key.

23. The method of claim 20, the implant abutment and the abutment receiving portion form a morse taper connection.

24. The method of claim 19, wherein the transfer abutment is longer than the implant abutment.

25. The method of claim 19, wherein the length of the transfer abutment is selected to prevent the model from interfering with the seating of the implant abutment on the implant analog.

26. The method of claim 20, wherein, after the second transfer key insertion step, the implant abutment is fabricated into a desired shape.

27. The method of claim 20, wherein, before step (h), a jig is fabricated and placed over an occlusal end of the implant abutment for providing a striking surface for driving implant abutment until the occlusal end of the implant abutment is level with a free end of the second transfer key.

28. The method of claim 19, wherein the outer surface of the transfer abutment comprises at least one retention element to provide secure attachment of the transfer abutment within a dental impression material.

29. The method of claim 20, after step (b), further comprising:
seating the implant abutment with an hollow tubular instrument having a striking surface corresponding to an occlusal end of the implant abutment, and
trimming the free end of the second transfer key to the same level as the occlusal end of the implant abutment.

30. The method of claim 20, wherein the second transfer key comprises a central bore for engaging with a root canal reamer to extract the second transfer key from the implant abutment seated on the implant analog member.

31. The method of claim 27, wherein the jig acts as a stop against the second transfer key to prevent over insertion of the implant abutment
